(19) United States
(12) Patent Application Publication
(10) Pub. No.: US 2004/0119734 A1
(43) Pub. Date: Jun. 24, 2004

(54) System for enabling a plurality of people to utilize an interactive program

(75) Inventors: Kuo-Ping Yang, Taipei (JP); Ching-Hsiang Shih, Taipei (JP)

Correspondence Address: BACON & THOMAS, PLLC, 625 SLATERS LANE, FOURTH FLOOR, ALEXANDRIA, VA, 22314

(73) Assignee: Kuo-Ping Yang, Taipei (TW)

(21) Appl. No.: 10/656,366

(22) Filed: Sep. 8, 2003

(30) Foreign Application Priority Data
Dec. 18, 2002 (TW) 091136570

(51) Int. Cl. G09G 5/00

(52) U.S. Cl. 345/733; 345/700

(57) ABSTRACT

A system includes a host computer and operational devices. The operational devices are connected to the host computer by a connection device and utilizable by users. The host computer is used for executing an interactive program and a control manner specifying program. The control manner specifying program has a first routine for distributing the operational instructions of the interactive program to at least two users so that the interactive program is used by at least two users, and a second routine for changing the distribution method of the operational instructions of the interactive program to the users.

### BACKGROUND OF THE INVENTION

1. Field of the Invention

The present invention relates to a system for enabling a plurality of people to utilize an interactive program and, more particularly, to a system that is applied in a school environment.

2. Description of Related Art

The typical interactive program, such as an interactive learning program, is mainly utilized by a single person. Some game programs, however, can be utilized by several people on a single machine, and through a network may be utilized by even more people.

There are two main types of interactive programs, which are discussed below.

Role playing: examples include fighting games, in which each user plays a role in the game and controls the role character by a plurality of predetermined keys on a keyboard. However, these predetermined keys cannot be changed, unless the original interactive program is modified.

Multiple identical operations: examples include most shooting games, in which every user has an operational device (such as a toy gun or a joystick) which has a plurality of identical operational functions, enabling each user to shoot a target. Again, though, the plurality of operational functions cannot be changed, and the program cannot be preset to adjust user limitations.

Therefore, prior art interactive programs for a plurality of people have many inconveniences, which are especially obvious in a teaching environment. The teacher cannot flexibly specify a plurality of students to utilize the interactive program, for example changing the number of students that utilize the interactive program at the same time.

### SUMMARY OF THE INVENTION

The main objective of the present invention is to provide a system for enabling a plurality of people to utilize an interactive program, which can flexibly assign different operational instructions to different users so that the user can cooperatively use the interactive program.

Another objective of the present invention is to provide a method for flexibly changing the manner of using an interactive program, such as changing to a different user or changing a plurality of operational instructions.

In order to achieve the above-mentioned objectives, the system for enabling a plurality of people to utilize an interactive program of the present invention has: a host computer and a plurality of operational devices. The plurality of operational devices are connected to the host computer by a connection device and utilizable by a plurality of users, wherein each operational device has a plurality of buttons, and the user can output a plurality of operational instructions to the host computer by pressing a corresponding button to use the interactive program. The host computer is used for executing an interactive program and a control manner specifying program to perform the following means:

a first means for distributing the plurality of operational instructions of the interactive program to at least two users so that the interactive program is used by at least two users; and

a second means for changing the distribution method of the plurality of operational instructions of the interactive program to the user.

If this system is applied in a class, it preferably further comprise a portable computer so that the teacher can use the portable computer in a very convenient manner to control the control manner specifying program in the host computer to execute the first means and the second means.

Other objectives, advantages, and novel features of the invention will become more apparent from the following detailed description when taken in conjunction with the accompanying drawings.

### BRIEF DESCRIPTION OF THE DRAWINGS

FIG. 1 illustrates a system for enabling a plurality of people to utilize an interactive program according to the present invention.

FIG. 2 shows a host computer according to the present invention.

FIG. 3 is a schematic drawing of an operational device according to the present invention.

FIG. 4 is a diagram of an operational device according to the present invention.

FIG. 5 is a diagram of a portable computer according to the present invention.

FIG. 6 is a diagram of a connection device according to the present invention.

FIG. 7 is an embodiment of the interactive program according to the present invention.

FIG. 8 illustrates a control manner specifying program according to the present invention.

FIG. 9 to FIG. 13 show embodiments of a plurality of operation instructions group distribution lists according to the present invention.

FIG. 14 to FIG. 16 show embodiments of a plurality of operational device distribution lists according to the present invention.

FIG. 17 to FIG. 18 show different embodiments of a displaying screen of a portable computer.

### DETAILED DESCRIPTION OF THE PREFERRED EMBODIMENT

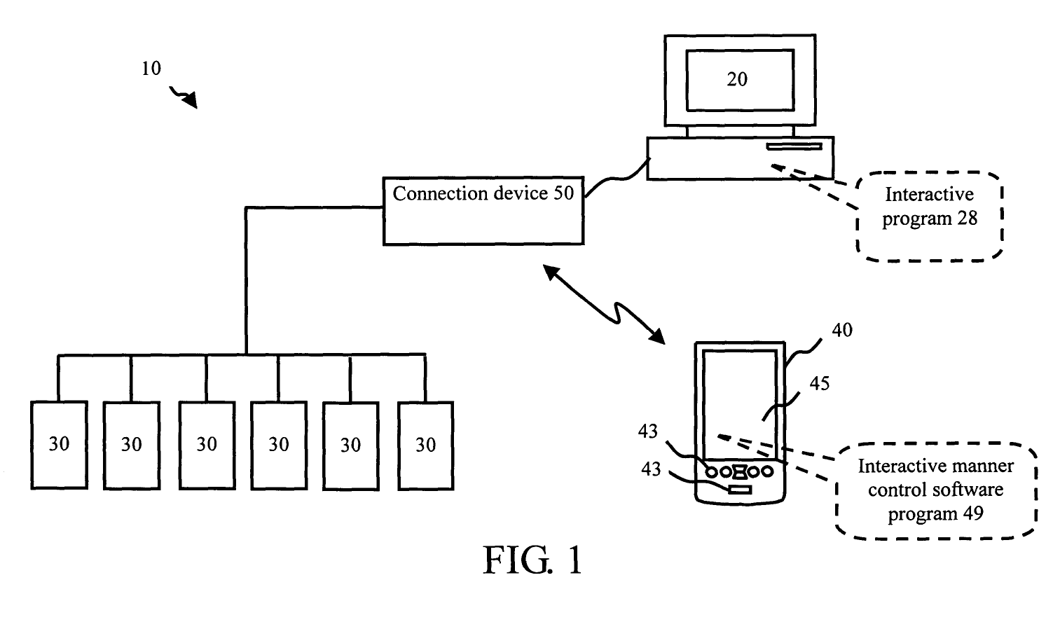

Please refer to FIG. 1. FIG. 1 is a structure drawing of a system for enabling a plurality of people to utilize an interactive program according to the present invention. The system 10 for enabling a plurality of people to utilize an interactive program can be applied in a computer environment supporting a teacher with a plurality of students.

A host computer 20 can be a typical computer. The host computer 20 is used to execute at least one interactive learning program 21. The interactive learning program 21 is simple quiz learning software, or complex quiz learning software. The host computer 20 outputs pictures for the teacher and the plurality of students. The output pictures can also be sent to a projector.

Each student uses an operational device 30 to serve as an input tool for the host computer 20, which output a plurality of operational instructions to the host computer 20 to control the interactive learning program 21. It is a preferred method that every student has one operational device 30, but it is also acceptable if several students share one operational device 30.

The teacher operates a portable computer 40, and the portable computer 40 can be a personal digital assistant (PDA). In the prior art system, the teacher operates the host computer 20 directly, but in the present invention, the teacher can move around with the portable computer 40 and use the portable computer 40 to control the host computer 20. However, the main characteristic of the present invention is that the teacher can use an interactive manner control software program 49 installed in the portable computer 40.

There is a connection device 50 in this embodiment. The connection device 50 is connected to the operational device 30 and the host computer 20 via cables, so that the operational instruction output by the operational device 30 can be received by the host computer 20. Furthermore, signals from the portable computer 40 are sent to the connection device 50 and then to the host computer 20. In this embodiment, the portable computer 40 is wirelessly connected to the connection device 50. It should be clear that any apparatus in the interactive learning system 10 can be connected with cables, or in a wireless manner. An additional item that should be noted is that if the host computer is an advanced model or supports a suitable design, the connection device 50 may be not necessary. For example, if the host computer 20 supports wireless communications, the portable computer 40 can communicate with the host computer 20 directly.

The following description relates to the hardware structure of the host computer 20, the operational device 30, the portable computer 40 and the connection device 50.

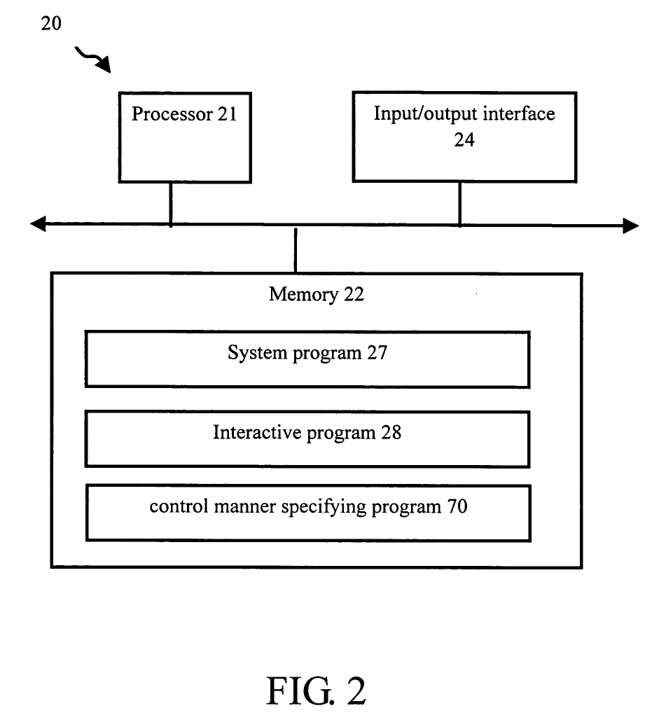

FIG. 2 is a structure drawing of a host computer according to the present invention. The host computer 20 can be a regular computer which comprises a processor 21, a memory 22 and an input/output interface 24. The memory 22 stores a system program 27, an interactive program 28 and a control manner specifying program 70 (the main characteristic of the present invention, which will be explained later).

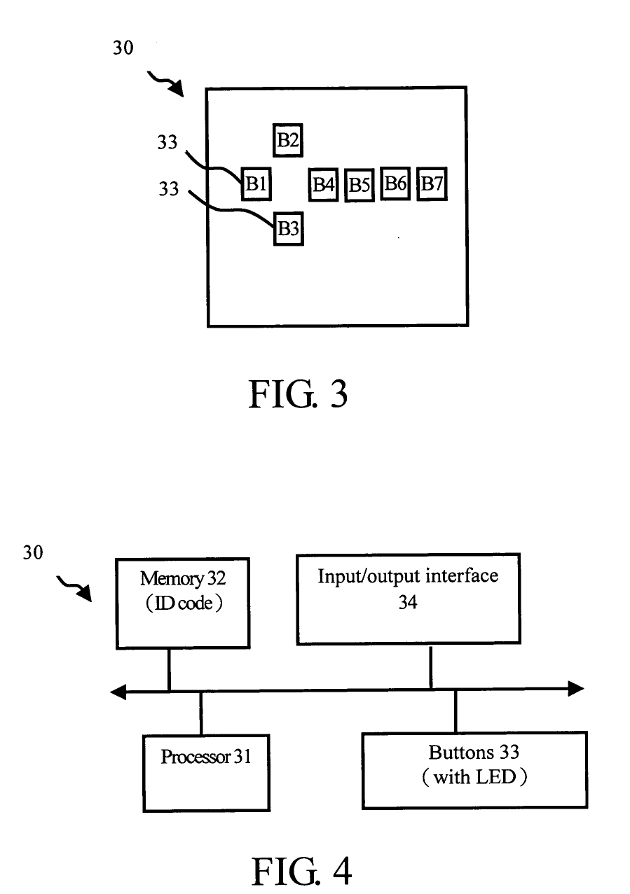

FIG. 3 is a schematic drawing of an operational device 30 according to the present invention. The operational device 30 can be box shaped with a plurality of buttons 33. This embodiment shows 7 buttons B1˜B7 on the operational device 30. Moreover, the operational device 30 can also have a touch screen (similar to a PDA), and in this case the plurality of buttons 33 may be visual buttons on the screen.

FIG. 4 is a diagram of the operational device 30 according to the present invention. The operational device 30 comprises a processor 31, a memory 32, the plurality of buttons 33 and an input/output interface 34 connected to the connection device 50. Each operational device 30 has a unique ID code, and the operational instruction is output with one ID code so that the host computer 20 can identify the corresponding operational device 30.

The operational device 30 may be a common electronic device, such as an external keyboard, but this is not the primary issue of the present invention, and so is not elaborated upon.

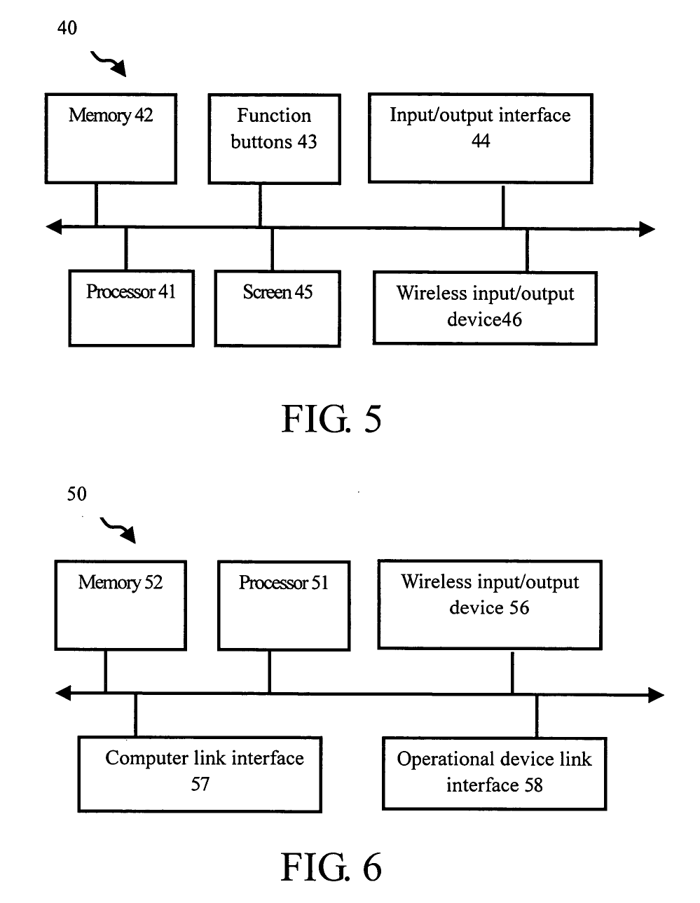

FIG. 5 is a diagram of a portable computer 40 according to the present invention. The portable computer 40 comprises a processor 41, a memory 42, a plurality of function buttons 43, an input/output interface 44, a screen 45 and a wireless input/output device 46. The portable computer 40 is similar to a standard computer. In the embodiment, the portable computer 40 uses the wireless input/output device 46 (such as an infrared port or a radio frequency port) to wirelessly transmit data to the connection device 50.

FIG. 6 is a diagram of a connection device 50 according to the present invention. The connection device 50 comprises a processor 51, a memory 52, a wireless input/output device 56, a computer link interface 57 and an operational device link interface 58. The wireless input/output device 56 corresponds to the wireless input/output device 46 of the portable computer 40 so that data may be transmitted between the two wirelessly. The computer link interface 57 is used for connecting to the host computer 20. The operational device link interface 58 is used for connecting to the plurality of operational devices 30. A primary function of the connection device 50 is to transmit signals between the host computer 20, the operational device 30 and the portable computer 40. The connection device 50 is a simple device, is not the primary issue of the present invention, and so will not be elaborated upon.

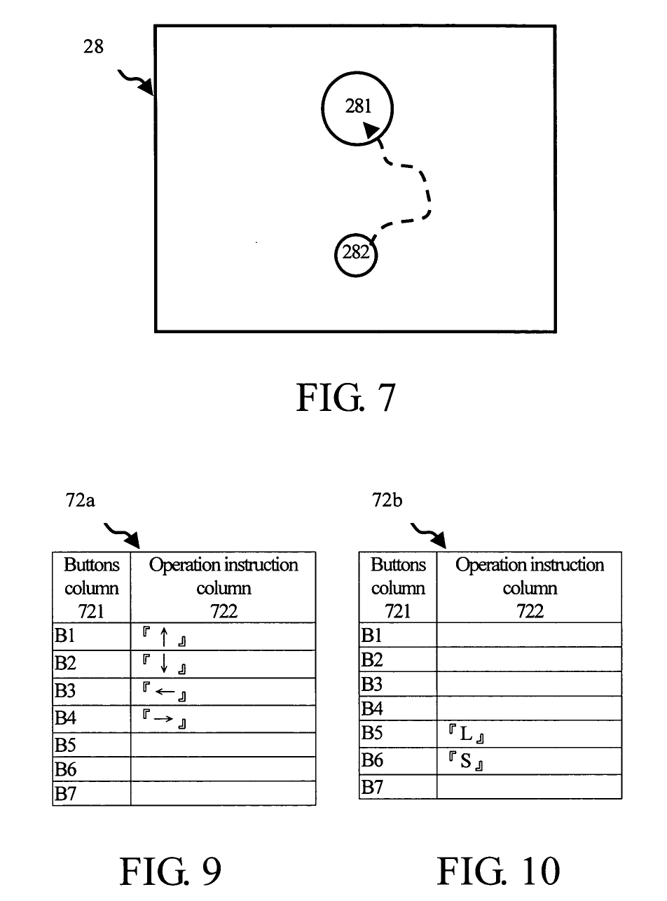

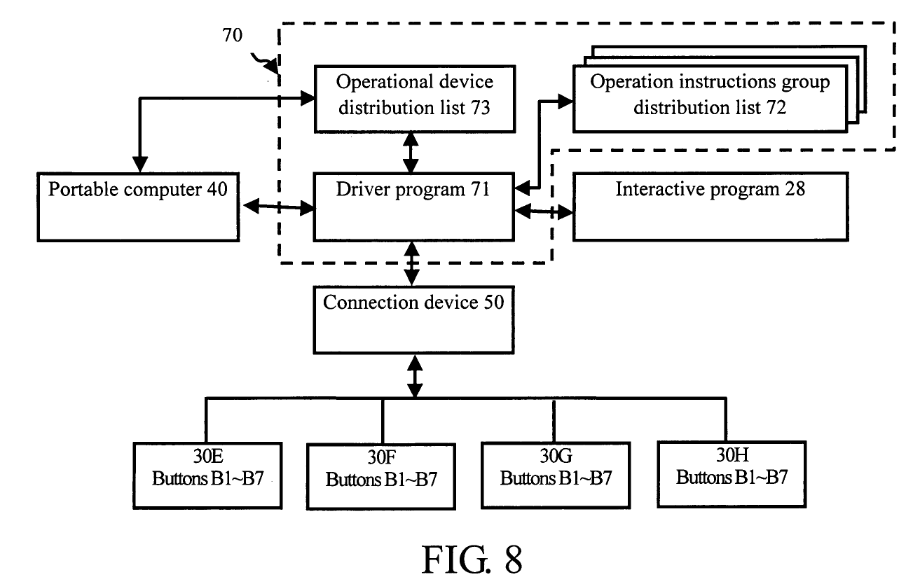

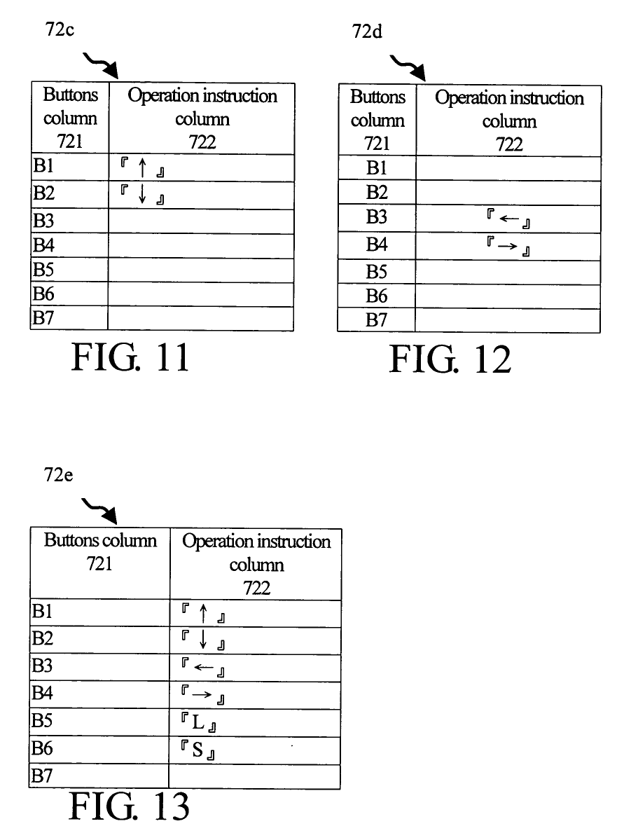

FIG. 7 is an embodiment of the interactive program according to the present invention. In FIG. 7, a target circuit 281 and a moveable circuit 282 are shown. In this embodiment, these are part of a game that requires a user to move the moveable circuit 282 to cover the target circuit 281. There are four operational instructions, “up”, “down”, “left” and “right”, used for controlling the interactive program 28 to move the moveable circuit 282 to the target circuit 281; there are two other operational instructions “L” and “S” used for “enlarge” and “shrink” to adjust a size of the moveable circuit 282. If a typical computer keyboard (not shown) is used to operate the interactive program 28, the operational instructions can be assigned to the buttons “↑”, “↓”, “←”, “→”, “L” and “S”. An objective of the present invention is enabling a plurality of people to utilize an interactive program 28, such as with two people working together, where one controls the buttons “↑”, “↓”, “←” and “→” to move the moveable circuit 282, and the other controls the buttons “L” and “S” to adjust the size of the moveable circuit 282. Please refer to FIG. 8 to FIG. 16 to understand the present invention.

FIG. 8 is a structure drawing of a control manner specifying program according to the present invention. The control manner specifying program 70 comprises a driver program 71, a plurality of operation instructions group distribution lists 72 and an operational device distribution list 73. The driver program 71 is used for processing input signals from the plurality of operational devices 30E˜30H and output the operational instructions to control the interactive program 28 according to the operation instructions group distribution list 72 and an operational device distribution list 73. In FIG. 8, four students use the operational devices 30E˜30H. Each operational device has seven buttons B1˜B7. Furthermore, the portable computer 40 can wirelessly control the host computer 20, either directly or via the connection device 50, to perform operations such as changing the operational device distribution list 73.

Please refer to FIG. 9 to FIG. 13. FIG. 9 to FIG. 13 show embodiments of a plurality of operation instructions group distribution lists according to the present invention. This embodiment shows five operation instructions group distribution lists 72a˜72e. Each operation instructions group distribution list has two columns; one is a button column 721, and another column is an operation instruction column 722. The button column 721 corresponds to the seven buttons B1˜B7 of the operational device 30. The operation instruction column 722 records a plurality of corresponding relations between the operation instructions and the buttons; in this embodiment the buttons are “↑”, “↓”, “←”, “→”, “L” and “S”.

Please refer to FIG. 9. The buttons B1˜B4 control “↑”, “↓”, “←”, “→”, operation instructions, and the buttons B5˜B7 control no operation instruction. Again, in FIG. 10 to FIG. 13, the operation instructions group distribution lists 72b˜72e divide the operation instructions into different groups to specify the operation instruction for the buttons B1˜B7. However, all the operation instructions can be specified in one operation instructions group distribution list, such as the operation instructions group distribution list 72e.

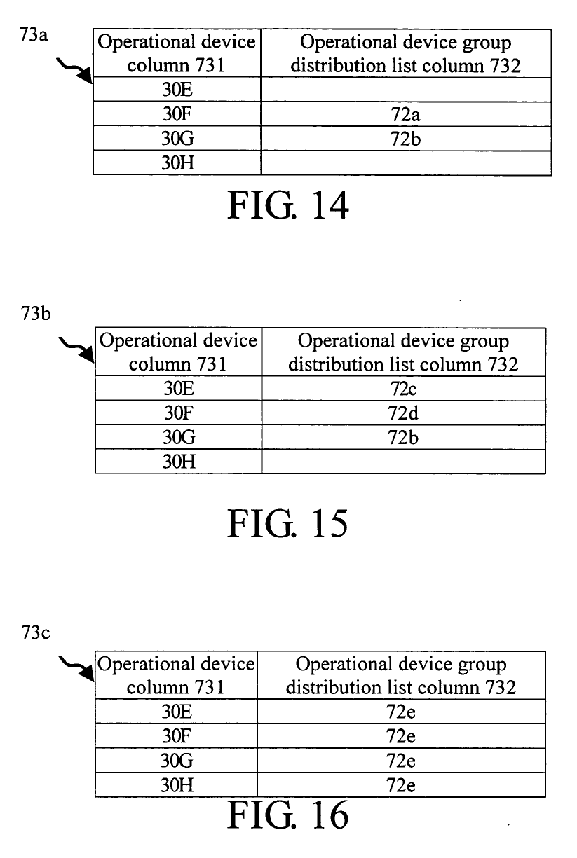

Please refer to FIG. 14 to FIG. 16. FIG. 14 to FIG. 16 show embodiments of a plurality of operational device distribution lists according to the present invention. A plurality of operational device distribution lists 73a˜73c have two columns; one is an operational device column 731, another is an operational device group distribution list column 732. The operational device column 731 corresponds to the four operational devices 30E˜30H, and the operational device group distribution list column 732 records the operation instructions group distribution list corresponding to each operation.

The following description will explain how the driver program 71 works with a plurality of operation instructions group distribution lists 72a˜72e and an operational device distribution list 73a. In this embodiment, only the operational device 30F and 30G can operate the interactive program 28, because in the operational device distribution list 73a the operational devices 30F and 30G separately correspond to the operation instructions group distribution lists 72a and 72b, but the operational devices 30E and 30H do not correspond to any operation instructions group distribution list. Moreover, the operational device 30F can only control the movement of the moveable circuit 282, and the operational device 30G can only control the size of the moveable circuit 282. The operational device 30F corresponds to the operation instructions group distribution lists 72a. In the operation instructions group distribution lists 72a, the buttons B1˜B4 respectively corresponds to “↑”, “↓”; “←”, “→”, operation instructions, and the buttons B5˜B7 correspond to no operation instruction. The user can thus press the buttons B1˜B4 to move the moveable circuit 282, but the buttons B5˜B7 perform no action. The operational device 30G corresponds to the operation instructions group distribution list 72b. The user of the operational device 30G can press the buttons B5 and B7 to execute “enlarge” and “shrink” operation instructions to control the size of the moveable circuit 282.

In FIG. 15, according to the operation instructions group distribution list 73b, the operational device 30E uses buttons B1˜B2 to control “↑” and “↓”; the operational device 30F corresponds to operation instructions group distribution list 72c. Therefore, the operational device 30F can use button B3 and B4 to control “←”, “→” operation instructions, and the operational device 30G can use button B3 and B4 to control “L” and “S”. Consequently, the interactive program 28 needs the three operational devices 30E, 30F and 30G to work together.

In FIG. 16, according to the operation instructions group distribution list 73c, each operational device 30E˜30H is assigned to operation instructions group distribution list 72e. The buttons B1˜B6 in operation instructions group distribution list 72 correspond to all “↑”, “↓”, “←”, “→”, “L” and “S” operation instructions, so any user of the operational devices 30E˜30H can operate the interactive program 28 with all the operation instructions.

Due to the above-mentioned operation instructions group distribution list 72 and the operational device distribution list 73, the teacher can flexibly operate the interactive program 28 by changing the operational device distribution list 73. For example, the teacher can assign the interactive program 28 to be operated by more than one user. One thing to be noted is that the plurality of operation instructions group distribution lists 72 are usually set in the host computer 20, and the teacher can change the operational device distribution list 73 during the class.

The teacher can directly use the host computer 20 to change the operational device distribution list 73, while using the portable computer 40 to do so would be even better, as this would enable the teacher to be anywhere in the classroom. Consequently, an interactive manner control software program 49 is installed in the portable computer 40 to change the operational device distribution list 73.

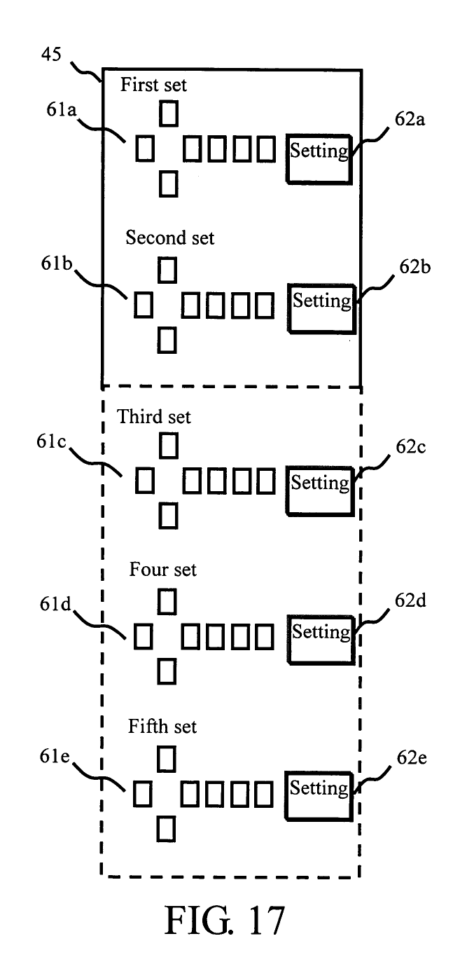

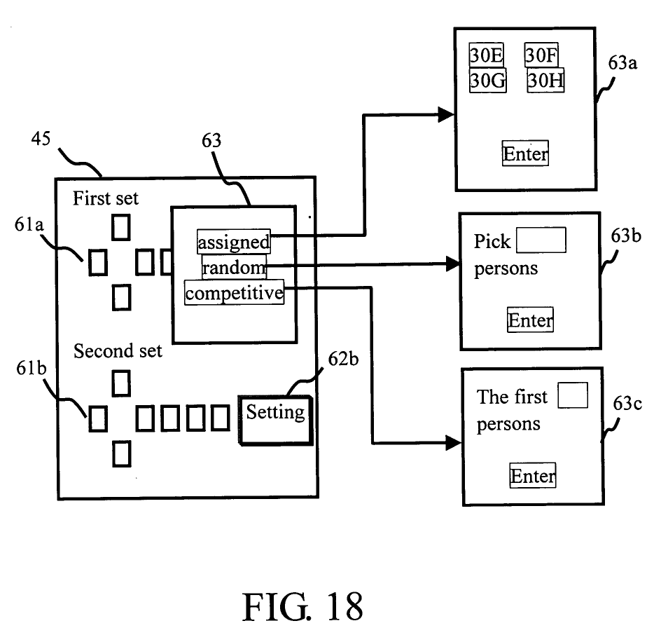

Please refer to FIG. 17 and FIG. 18. FIG. 17 to FIG. 18 show different embodiments of a displaying screen of a portable computer. The interactive manner control software program 49 is used to display an operation interface and send the change that the teacher has made to the host computer 20 to change the operational device distribution list 73. The screen 45 of the portable computer 40 displays a first set of visual buttons 61a and a second set of visual buttons 61b. Of course, the screen 45 could show even more sets of visual buttons. In this embodiment, there are five sets of visual buttons 61a˜61e shown on the screen 45, which correspond to the operation instructions group distribution lists 72a˜72e.

For example, when the teacher presses a “setting” button 62a, as shown in FIG. 18, a setting window 63 appears on the displaying screen 45. There are three interactive manner options, “assigned”, “random” and “competitive”, displayed in the setting window 63.

If the teacher selects the “assigned” option, an assigning window 63a is shown. The assigning window 63a shows the operational devices 30E˜30H (could also be a plurality of student numbers, or a plurality of seat numbers, a plurality of ID codes which represent operational devices) as selection options for the teacher. If the teacher assigns the first set of visual buttons 61a (which corresponds to the operation instructions group distribution lists 72a) to the operational device 30F, the second set of visual buttons 61b (which corresponds to the operation instructions group distribution lists 72b) to the operational device 30G, and does not assign the third˜fifth sets of visual buttons 61c˜61e, the operational device distribution list 73a is generated.

If the teacher selects the “random” option, a random window 63b is shown. The teacher can input the number of people desired to answer the question, such as one person, and the interactive manner control software 49 will randomly select one student.

If the teacher selects the “competitive” option, a competitive window 63c is shown. The teacher can input the number of people that will be allowed to answer the question, such as allowing only one person to operate the interactive program 28.

The embodiments show in FIG. 17 and FIG. 18 are mainly used to explain how to use the portable computer 40 to change the operational device distribution list 73. Other interface designs are also possible, and are not the point of the present invention.

The invention has been described using exemplary preferred embodiments. However, for those skilled in this field the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

Although the present invention has been explained in relation to its preferred embodiment, it is to be understood that many other possible modifications and variations can be made without departing from the spirit and scope of the invention as hereinafter claimed.

What is claimed is:

1. A system for enabling a plurality of people to utilize an interactive program, the system comprising:
a host computer comprising a processor and a memory, wherein the memory stores an interactive program executable by the processor, the interactive program accepting a plurality of different operational instructions;
a plurality of operational devices utilizable by a plurality of users, wherein each operational device has a plurality of buttons, and the user can output a plurality of operational instructions to the host computer by pressing a corresponding button to use the interactive program, wherein each operational device has a unique ID code, and the operational instruction is output with one ID code so that the host computer is capable of identifying each operational device;
the memory of the host computer further comprising a control manner specifying program executable by the processor to perform the following means:
a first means for distributing the plurality of operational instructions of the interactive program to at least two users so that the interactive program is used by at least two users; and
a second means for changing the distribution method of the plurality of operational instructions of the interactive program to the user.

2. The system of claim 1 further comprising a connection device, operational instructions from the plurality of operational devices being sent to the host computer via the connection device.

3. The system of claim 1 further comprising a portable computer, the portable computer wirelessly controlling the control manner specifying program of the host computer to execute the first means and the second means.

4. The system of claim 2 wherein the connection device has wireless communications functionality, and the system further comprises a portable computer, the portable computer wirelessly controlling the control manner specifying program of the host computer to execute the first means and the second means.

5. The system of claim 1 wherein the control manner specifying program comprises:
an operation instructions group distribution list, each operation instruction group recording a plurality of corresponding relations between the operation instructions and the buttons; and
an operational device distribution list for recording the operation instructions group distribution list corresponding to each operation;
wherein data within the operation instructions group distribution list and the operational device distribution list is changeable to effect the second means.

6. The system of claim 5 further comprising a portable computer, the portable computer changing data of the operation instructions group distribution list in a wireless manner.

7. A computer readable media storing a specified control manner program, the specified control manner program executable with an interactive program in a computer so that the interactive program can be utilized by a plurality of users, wherein the interactive program accepts a plurality of different operational instructions, and the plurality of users can operate the interactive program via different operational devices, the specified control manner program comprising:
a first program code for distributing the plurality of operational instructions of the interactive program into different groups; and
a second program code for distributing the plurality of operational instructions to the plurality of operational devices.

8. The computer readable media as claimed in claim 7 further comprising driver program code for processing the plurality of operational devices and outputting the operational instruction to control the interactive program according to the first program code and the second program code.

9. A computer readable media storing a specified control manner program, the specified control manner program executable with an interactive program in a computer so that the interactive program supports a plurality of users, wherein the interactive program accepts a plurality of different operational instructions, and the plurality of users operate the interactive program via different operational devices having a plurality of buttons, the specified control manner program comprising:
an operation instructions group distribution list, each operation instruction group recording a plurality of corresponding relationships between the interactive programs and the buttons; and
an operational device distribution list for recording the operation instructions group distribution list corresponding to each operation.

10. The computer readable media as claimed in claim 9 further comprising a driver program code for processing the plurality of operational devices and outputting the operational instruction to control the interactive program according to the operation instructions group distribution list and the operational device distribution list.
